(19) United States
(12) Patent Application Publication
(10) Pub. No.: US 2022/0348519 A1
(43) Pub. Date: Nov. 3, 2022

(54) GREEN COATING CONTAINING BIOSTIMULANTS FOR HYGROSCOPIC SUBSTRATES

(71) Applicants: ArrMaz Products Inc., Mulberry, FL (US); Tenfold Technologies, LLC d/b/a Agricen Sciences, Pilot Point, TX (US)

(72) Inventors: Lucas Moore, Dover, FL (US); Anna McLeroy, Ft. Meade, FL (US); Mark Ogzewalla, Winter Haven, FL (US); Curt Hill, Little Elm, TX (US)

(73) Assignees: ArrMaz Products Inc., Mulberry, FL (US); Tenfold Technologies, LLC d/b/a Agricen Sciences, Pilot Point, TX (US)

(21) Appl. No.: 17/731,037

(22) Filed: Apr. 27, 2022

Related U.S. Application Data
(60) Provisional application No. 63/180,773, filed on Apr. 28, 2021.

(51) Int. Cl. C05G 5/27; C05G 3/80; C05F 11/08; C09K 17/18

(52) U.S. Cl. CPC C05G 5/27; C05G 3/80; C05F 11/08; C09K 17/18

(57) ABSTRACT

A coating for hygroscopic substrates comprising a tackifier, a cutting oil, and an aqueous solution comprising biostimulant. The coating may be a green coating that acts both as a dust suppressant as well as a carrier for biostimulants on hygroscopic substrates.

### CROSS REFERENCE

This application is based on and claims priority to U.S. Provisional Patent Application No. 63/180,773 filed Apr. 28, 2021.

### BACKGROUND OF THE INVENTION

### Field of the Invention

This invention relates generally to coatings for hygroscopic substrates, and more particularly, but not by way of limitation, to a green coating that acts both as a dust suppressant as well as a carrier for biostimulants on hygroscopic substrates, where a green coating is a non-petroleum based coating, such as those produced from plant or animal, but not petroleum.

### Description of the Related Art

Plants require a wide range of nutrients for optimal crop growth and fruit production. Nutrients come from the air or through adsorption through the root. Some nutrients are naturally in the soil, while others are added in the way of fertilizers. Either way, the degree of adsorption is dependent on the solubility or availability of these nutrients.

It has long been known that microbial activity has an impact on mineral oxidation state and solubility. An example of this is seen in acid mine drainage. The same is true for the agricultural industry. Companies have developed biostimulant packages that consist of either live microbes or dead microbes, metabolites, plant extracts, plant hormones, etc. and have found successes in applying these to assist with crop nutrient uptake.

The challenge of using biostimulants is the impact of water on the substrate.

Based on the foregoing, it is desirable to provide a fertilizer coating that incorporates biostimulant technology.

It is further desirable for the fertilizer coating to provide dust control, resistance to moisture uptake, and/or resistance to caking.

In particular, it is desirable for the fertilizer coating to adsorb water from the biostimulant, thus preventing it from strongly interacting with the surface of the substrate granule.

### SUMMARY OF THE INVENTION

In general, in a first aspect, the invention relates to a coating for hygroscopic substrates comprising a tackifier, a cutting oil, and an aqueous solution comprising biostimulant. The tackifier may be sugar syrup such as corn syrup, polysaccharides, molasses, sugars, and/or starches, the cutting oil may be a polyol such as glycerin, and the biostimulant may be Acidovorax facilis, Bacillus licheniformis, subtilis, oleronius, marinus, megaterium, rhodococcus rhodochrous, or a combination thereof. The biostimulant may contain metabolites, hormones, inhibitors, or a combination thereof.

In particular, the tackifier may be corn syrup and the cutting oil may be tech grade glycerin, and the corn syrup and tech grade glycerin may be present in a 4 to 6 ratio. Alternately, the tackifier may be corn syrup and the cutting oil may be crude glycerin, and the corn syrup and tech grade glycerin may be present in a 55 to 45 ratio. The aqueous solution comprising biostimulant may comprise 1% to 50% by weight of the coating, or more specifically 10% to 30% by weight of the coating. More specifically, the aqueous solution comprising biostimulant may comprise 15% by weight of the coating.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a coating technology that combines fertilizer application with biostimulant application. The coating may adsorb water from the biostimulant, thus preventing it from strongly interacting with the surface of the substrate granule.

The coating may comprise a tackifier, a cutting oil, and an aqueous solution containing biostimulant. The tackifier may be corn syrup, or the tackifier may be any sugar or polysaccharide-based material, such as molasses, syrups, gums, starches, etc., or any combination thereof. The cutting oil or solvent may be glycerin, or the cutting oil or solvent may be any polyol or diol, fatty acids, acid oil, or triglycerides, or water and a thickening agent such as water soluble polymer and starch, or any combination thereof. The cutting oil may aid in the distribution of the tackifier, and may also offer some dust reduction advantages.

The biostimulant may be any material that contains a substance(s), microorganism(s), or mixtures thereof, that, when applied to seeds, plants, the rhizosphere, soil or other growth media, acts to support a plant's natural nutrition processes independently of the material's nutrient content, thereby improving nutrient availability, uptake or use efficiency, tolerance to abiotic stress, and consequent growth, development, quality or yield. For example, the biostimulant may be a biocatalyst or biochemical. Examples of biostimulants may include, but are not limited to, plant and other extracts, microbial agents, living organisms such as, for example, endophytes, fungi, yeasts, and bacteria, or other desired biologicals. Examples of biocatalysts may include one or more species from bacterial genu, such as, but not limited to, bacillu thizobium, azobacter, and azospirillu, one or more species from fungal genus or fungi such as aspergillus, mycorhizzae, beauveria, metarhzium, and Trichoderma, and/or one or more species from a yeast genus such as saccharomyces, schizosaccharomyces, sporobolomyces, candida, trichosporon, and thodosporidium. Other biologicals may not be microorganisms but rather may be small molecule and petide-based compositions such as metabolites, petides, lipopetides, hormones, peptide hormones, siderophores, glycopeptides, humates, surfactants, vitamins, enzymes, amino acids, and amino acid derivatives, and nucleic acids and nucleic acid derivatives. In particular, biocatalysts may include bacillus linchniformus (>0.01%) and may be present in the coating at a rate of 1% to 50% by weight, or more specifically 20% by weight, or alternately 4.13% by weight to 11.26% by weight. Other possible components may include anticaking agents, dispersants, colorants, odeur modifiers, or combinations thereof.

The tackifier and cutting oil may be blended in a ratio to produce a desired viscosity, tackiness, and overall coating physical property and dust reduction performance. For example, a blend of 40% corn syrup and 60% tech grade glycerin may produce a coating with a viscosity of 75-200 cP at 140 deg F. Crude glycerin may be used to produce a coating with the same viscosity by increasing the amount of corn syrup, producing a blend of 55% corn syrup and 45% crude glycerin. The cutting oil may be omitted entirely, but heating may be required for coating application. The aqueous solution containing biostimulant may be added in any desired quantity. For example, aqueous solution containing biostimulant may be added at a rate of 5% to 30% be weight, or more specifically at a rate of 15% by weight.

The coating may be applied by producers, namely fertilizer plants, or by blenders, such as at warehouses, by dosing a controlled amount onto a bed of fertilizer granules and tumbling or mixing. Alternately, the coating may be applied as a top coat, without mixing.

By combining biostimulant technology with the appropriate coating technology, the fertilizer may provide a boost from the stimulant, as well as possess dust control and/or resistance to moisture uptake and/or resistance to caking.

### EXAMPLE

A coating containing a complex blend of metabolites was prepared by combining 60% tech grade glycerin with 40% corn syrup and mixing, to produce a coating with a viscosity at 140 deg F. of 75-200 cP. This was done to generate a coating with a viscosity that is easily manageable onsite. The coating was then blended with 15% biostimulant in an aqueous solution, which contained metabolites from bacillus licheniformus.

The biostimulant-containing green dust control coating was applied to potash granules and evaluated for caking tendencies and dust generation. The results are summarized in the following table:

| | Caking | Dust | Hard- |
|---|---|---|---|
| Sample | Reduction (%) | Reduction (%) | ness |
| Uncoated Control | — | — | 10 |
| Green Coating Only | 61 | 93 | 10 |
| (6 lb/ton) | | | |
| Green Coating + 15% | 49 | 82 | 9 |
| biostimulant (6 lb/ton) | | | |
| Green Coating + 15% | 47 | 89 | 8 |
| biostimulant (7.4 lb/ton) | | | |

As can be seen from the foregoing, the cake strength was reduced with the green coating, even with the biostimulant. Dust reduction was also observed for the green coating containing biostimulant. While the addition of the biostimulant did reduce dust reduction performance slightly, it could potentially be regained by compensating the tackifying agent with increased dosage. Data suggests that hardness is maintained and no potash degradation was observed. It is notable that adding the aqueous biostimulant to the fertilizer did not have a negative impact to the fertilizer.

Applying a tailor-made coating that contains a biostimulant may allow for higher levels of micronutrient adsorption, while also reducing the dust generated. The coating may also be modified to improve both moisture update and caking tendencies.

Whereas, the devices and methods have been described in relation to the drawings and claims, it should be understood that other and further modifications, apart from those shown or suggested herein, may be made within the spirit and scope of this invention.

What is claimed is:

1. A coating for hygroscopic substrates comprising:
a tackifier;
a cutting oil; and
an aqueous solution comprising biostimulant.

2. The coating of claim 1 where the aqueous solution comprising biostimulant comprises 1% to 50% by weight of the coating.

3. The coating of claim 1 where the aqueous solution comprising biostimulant comprises 10% to 30% by weight of the coating.

4. The coating of claim 1 where the aqueous solution comprising biostimulant comprises 15% by weight of the coating.
